(19) United States
(12) Patent Application Publication
(10) Pub. No.: US 2005/0180462 A1
(43) Pub. Date: Aug. 18, 2005

(54) Apparatus and method for reproducing ancillary data in synchronization with an audio signal

(76) Inventor: Eun-jik Yi, Yongin-si (KR)

Correspondence Address: HARNESS, DICKEY & PIERCE, P.L.C., P.O. BOX 8910, RESTON, VA, 20195, US

(21) Appl. No.: 11/058,410

(22) Filed: Feb. 16, 2005

(30) Foreign Application Priority Data
Feb. 17, 2004 (KR) 2004-10418

(51) Int. Cl. H04H 1/04

(52) U.S. Cl. 370/487

(57) ABSTRACT

An apparatus and method for reproducing ancillary data in synchronization with audio data. An audio/video reproducing apparatus may receive audio data and ancillary data from separate data sources, and synchronize the ancillary data with the audio data. The synchronization may enable, for example, music lyrics and/or subtitles of movies to be displayed to a user. The displayed data may provide reproduced audio data with corresponding images or text for each sentence of text data displayed. Additionally, currently pronounced text data and other displayed text data may be displayed in different color.

### BACKGROUND OF THE INVENTION

This application claims the priority of Korean Patent Application No. 2004-10418, filed on Feb. 17, 2004, in the Korean Intellectual Property Office, the disclosure of which is herein incorporated by reference in its entirety.

1. Field of the Invention

The present invention relates to an audio/video reproducing apparatus and method for reproducing ancillary data in synchronization with an audio signal. Ancillary data and audio data stored in separate data storage units may be synchronized together and displayed on a display device.

2. Description of the Related Art

Audio signals may be reproduced by different types of devices, for instance a CD (compact disc) player, a DVD (digital video disk) player, a MP3 (MPEG layer 3) player, and/or an accompaniment machine (karaoke). An audio signal may be simultaneously reproduced with image signals, for example, a user may watch a foreign movie and understand the audio dialogue of the movie via subtitles. A user may hear text pronunciations and/or read text via subtitles while viewing still images or moving-images displayed on a screen. A user may also view still images or moving-images and/or read currently pronounced text displayed via subtitles while listening to music.

FIG. 1 illustrates a block diagram of a conventional audio/video reproducing apparatus 100. Referring to FIG. 1, a decoder 110 may receive and decode compressed audio data streams. An input audio data stream may be, for example, a MPEG-based format compatible with a DVD player. An audio data stream may be stored as a custom file type suitable for a MP3 (MPEG layer 3) player or a karaoke machine. Audio signal output unit 120 may output an audio signal for driving a speaker using decoded audio data DECAUD. A video signal output unit 130 may output a video signal for driving a display device, for example an LCD, by using decoded video data DECVD.

Conventional audio/video reproducing devices may be limited in their capabilities to reproduce image information and subtitles. In the conventional audio/video reproducing apparatus 100 of FIG. 1, the decoder 110 may decode ancillary data used for subtitles and/or background images (still images or moving-images). A compressed audio data stream, which may be provided to the decoder 110, may include audio data and/or ancillary data. An audio data stream, which includes audio data and data for subtitles and background images, may be decoded by a conventional audio/video reproducing device, however, the device may be required to provide decoding for audio data and ancillary data. Also, decoding capacity limitations may limit the amount of ancillary data which may be included in an audio data stream. Therefore, conventional audio/video reproducing devices may be required to have ancillary data decoding capabilities, and the amount of ancillary data that may be included in an audio data stream may be limited.

### SUMMARY OF THE INVENTION

Exemplary embodiments of the present invention is directed to an audio/video reproducing apparatus and method, which may be configured to receive ancillary data separate from audio data and reproduce the ancillary data in synchronization with the audio data.

According to an exemplary embodiment of the present invention, an audio/video reproducing apparatus may include an audio data storage unit for storing an audio data stream, an ancillary data storage unit for storing ancillary data, and a decoder for decoding the audio data stream and outputting decoded audio data and an audio synchronization signal. The audio/video reproducing apparatus may further include a processor for extracting ancillary data corresponding to the audio synchronization signal, in response to an ancillary data request signal, and a synchronization and ancillary data output unit for analyzing the extracted ancillary data and outputting display data in synchronization with the audio synchronization signal. A video controller may also be included as part of the audio/video reproducing apparatus for extracting text data corresponding to pronounced audio data, which may be displayed on a display device when the decoded audio data is pronounced by an audio device.

Exemplary embodiments of the present invention may include data frames, for example, a seek control frame, a video control frame and/or a text data frame. The seek control frame may include information regarding an audio data frame location, a video control frame location and/or a text data frame location corresponding to the audio data frame location. The video control frame may include, identity information indicating whether or not the text data exists in a sentence of a previous audio frame, text order information, frame length information of text data corresponding to pronounced audio data, and/or information for background image data corresponding to the video control frame location. The text data frame may include text count information and text data.

Exemplary embodiments of the present invention may include background image data and the text data, which may be output in synchronization with an audio synchronization signal. The video controller may extract background image data corresponding to the pronounced audio data, which may be displayed on a display device.

Another exemplary embodiment of the present invention may provide a method including extracting audio data from a first storage unit, decoding the audio data, outputting the decoded audio data, and extracting at least one audio synchronization signal using the decoded audio data. The method may also include extracting ancillary data corresponding to the at least one audio synchronization signal from a second storage unit in response to an ancillary data request signal, and outputting display data in synchronization with the at least one audio synchronization signal. The method may further include extracting text data from the display data and/or displaying the text data on a display when the audio data is pronounced by an audio device.

Another exemplary embodiment of the present invention may provide a method including extracting audio data in response to a request for reproduction of at least one audio file, decoding the audio data, extracting an audio synchronization signal using the decoded audio data, and generating an audio signal from the decoded audio data for driving an audio device.

Another exemplary embodiment of the present invention may provide a method including extracting at least one audio synchronization signal using decoded audio data, extracting ancillary data corresponding to the at least one audio synchronization signal in response to an ancillary data request. The method may also include outputting display data in synchronization with the at least one audio synchronization signal, extracting text data from the display data and displaying the text data on a display when the decoded audio data is pronounced by an audio device.

### BRIEF DESCRIPTION OF THE DRAWINGS

The present invention will become more apparent to those of ordinary skill in the art by describing, in detail, exemplary embodiments thereof with reference to the attached drawings, which are given by way of illustration only and thus do not limit the exemplary embodiments of the present invention.

FIG. 1 is a block diagram illustrating a conventional audio/video reproducing apparatus;

FIG. 2 is a block diagram illustrating an audio/video reproducing apparatus according to an exemplary embodiment of the present invention;

FIG. 3 is a flowchart illustrating an operation of the audio/video reproducing apparatus of FIG. 2;

FIGS. 4A-4C are exemplary views of ancillary data frames according to an exemplary embodiment of the present invention;

FIG. 5 illustrates a correlation between an audio data stream and an ancillary data stream according to an exemplary embodiment of the present invention;

FIG. 6 illustrates a seek control frame of FIG. 4A according to an exemplary embodiment of the present invention; and

FIG. 7 illustrates an exemplary frame designation of a frame location address of an audio data stream according to an exemplary embodiment of the present invention.

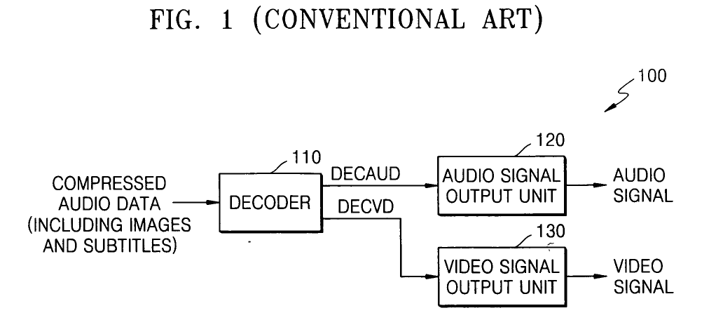

### DETAILED DESCRIPTION OF THE EXEMPLARY EMBODIMENTS OF THE PRESENT INVENTION

Hereinafter, exemplary embodiments of the present invention will be described in detail with reference to the appended drawings. The reference numbers described below refer to similar components throughout the drawings.

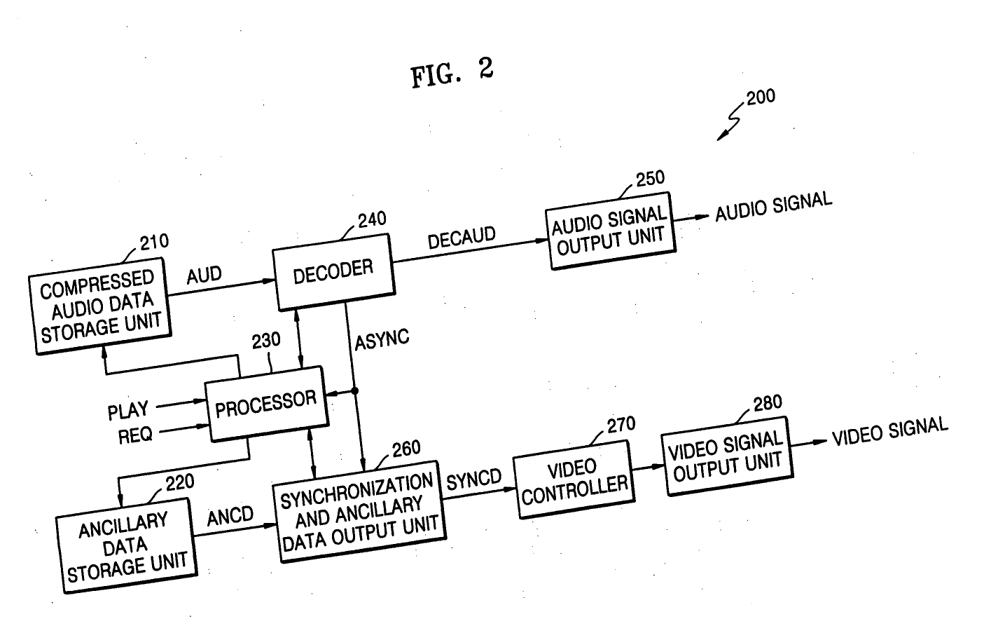

FIG. 2 illustrates a block diagram of an audio/video reproducing apparatus 200 according to an exemplary embodiment of the present invention. Referring to FIG. 2, the audio/video reproducing apparatus 200 may include, for example, a compressed audio data storage unit 210, an ancillary data storage unit 220, a processor 230, a decoder 240, an audio signal output unit 250, a synchronization and ancillary data output unit 260, a video controller 270, and a video signal output unit 280.

The audio/video reproducing device 200 may be used to reproduce audio data and video data simultaneously. The device may be, for example, in the form of a DVD player, a MP3 player, and/or a karaoke device.

The compressed audio data storage unit 210 may be used to store audio data streams. An audio data stream may be compressed according to the MPEG standard and thus may be played, for example, by a DVD player. An example of an audio/video reproducing device, for instance a MP3 player, and/or a karaoke device may store audio data streams of a specific type of file format suitable for a specified type of data reproducing device.

The ancillary data storage unit 220 may be used to store ancillary data, for example, text subtitles and/or background images. In a conventional decoding technique, ancillary data corresponding to subtitles and background images may be combined with audio data in a compressed audio data stream. In an exemplary embodiment of the present invention, the ancillary data storage unit 220 may store ancillary data separate from a compressed audio data stream and/or the ancillary data may be output in synchronization with decoded audio data as needed. A separate data storage unit (i.e., ancillary data storage unit 220) may reduce the amount of memory required by a decoder using a conventional decoding technique. Additionally, the ancillary data may be stored in a different file format, thus additional information including, for example, still images or moving-images for background images and/or text information for subtitles, may be stored in the ancillary data storage unit 220.

The processor 230 may extract an audio data stream from the compressed audio data storage unit 210 in response to a user input, for example a play signal PLAY. The play signal PLAY may be generated when a user selects an audio file and/or requests reproduction of the audio file. As a result of the user input the decoder 240 may decode an audio data stream AUD extracted from the compressed audio data storage unit 210, and output decoded audio data DECAUD and/or an audio synchronization signal ASYNC. The audio synchronization signal ASYNC may be generated based on a frame number included in the compressed audio data stream AUD. The decoded audio data DECAUD may be input to the audio signal output unit 250, which may generate an audio signal for driving an audio device, for example a speaker.

The processor 230 may extract ancillary data ANCD corresponding to the audio synchronization signal ASYNC from the ancillary data storage unit 220, in response to an ancillary data request signal REQ. Further, the processor 230 may control the operations of the compressed audio data storage unit 210, the ancillary data storage unit 220, the decoder 240, the audio signal output unit 250, the synchronization and ancillary data output unit 260, the video controller 270, and/or the video signal output unit 280.

The ancillary data request signal REQ may be generated when a user desires to view subtitles and/or background images. Viewing subtitles and/or background images may require reproduction of an ancillary data file. The ancillary data request signal REQ may be generated simultaneously with the beginning of an audio file reproduction operation, or may be generated when the user requests reproduction of the ancillary data file at a time intermittent to audio file reproduction.

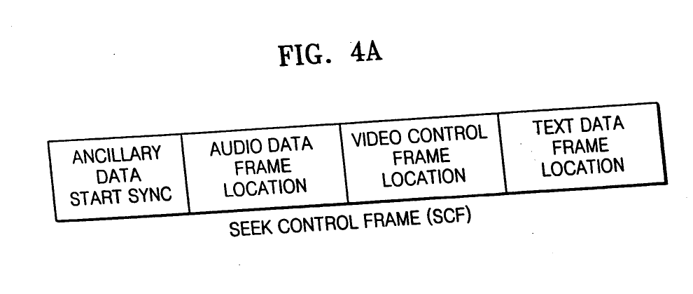

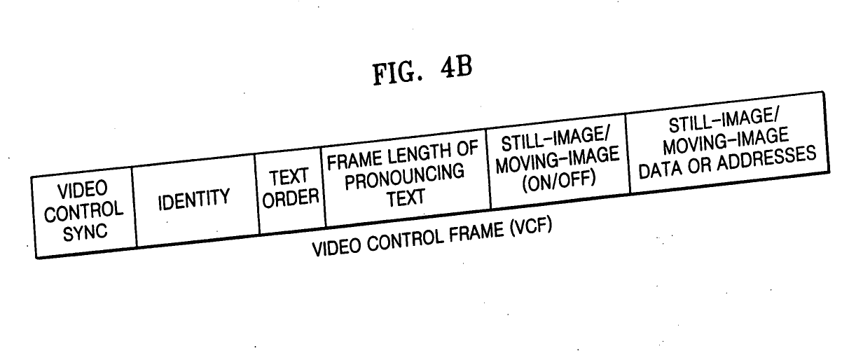

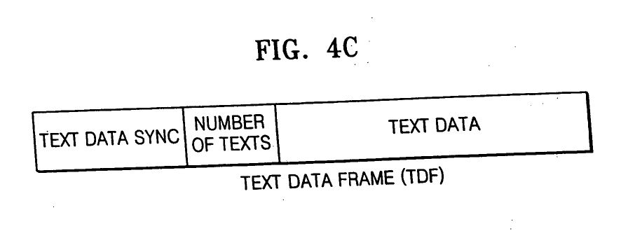

Ancillary data ANCD may be extracted from the ancillary data storage unit 220. The ancillary data may be generated as a seek control frame SCF as illustrated in an exemplary embodiment of FIG. 4A. Referring to FIG. 4A the SCF may include, for example, a video control frame VCF and/or a text data frame TDF.

The synchronization and ancillary data output unit 260, according to an exemplary embodiment of the present invention, may be used to analyze ancillary data ANCD extracted from the ancillary data storage unit 220. The synchronization and ancillary data output unit 260 may also output display data SYNCD. The display data SYNCD may correspond to and/or be in synchronization with the audio synchronization signal ASYNC. The video controller 270 may extract text data from the display data SYNCD. The extracted text data may correspond to the pronunciation of the audio data, and may be displayed on a display device, for example a LCD. The text data may be displayed when the decoded audio data DECAUD is output by an audio device, for example a speaker.

The display data SYNCD, according to an exemplary embodiment of the present invention may include background image data and/or text data. The video controller 270 may also extract background image data corresponding to the output audio data in addition to extracting text data from the display data SYNCD. The background image data may be data for a still image and/or for a moving-image and may be displayed on a display device. The text data and background image data, which may be extracted from the display data SYNCD, may be provided as input to the video signal output unit 280. The video signal output unit 280 may generate a video signal for driving a display device, for example, a LCD. The video signal may include three color signals (i.e., Red, Green, Blue) mixed together, which represent background images and/or an on-screen signal for text images.

Hereinafter, the operations of the audio/video reproducing apparatus 200 according to an exemplary embodiment of the present invention will be described in more detail.

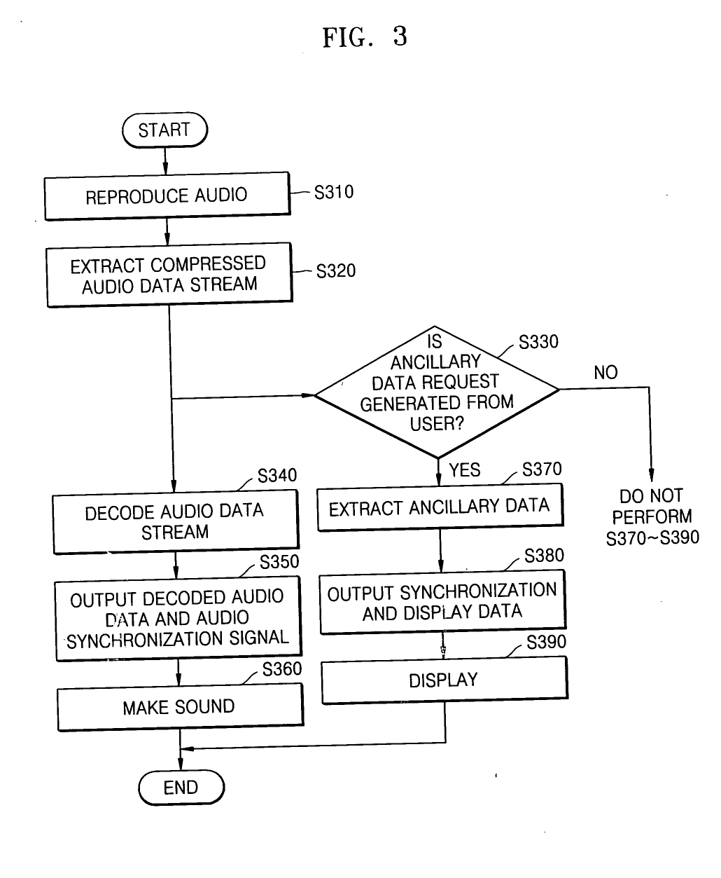

FIG. 3 is a flowchart illustrating an exemplary operation of the audio/video reproducing apparatus 200 of FIG. 2. Referring to FIGS. 2 and 3, the processor 230 may extract a compressed audio data stream AUD from the audio data storage unit 210. The compressed audio data stream AUD may be generated from a play signal PLAY, which may be initiated by a user request for reproduction of an audio file, in S310. The compressed audio data stream AUD may be extracted and/or input to the decoder 240, in S320. If no request for reproduction of an ancillary data file is received (i.e., no input request from a user), then an ancillary request signal REQ may not be generated. Therefore decoder 240 may only decode the audio data stream AUD extracted from the audio data storage unit 210, in S330 and S340.

The decoder 240 may output a decoded audio data stream DECAUD and/or extract an audio synchronization signal ASYNC based on the decoded audio data stream DECAUD, in S350. The decoded audio data DECAUD may be input to the audio signal output unit 250, which may generate an audio signal for driving an audio device, for example a speaker. The audio device may output sounds that correspond to the decoded audio data stream DECAUD, in S360. Decoding performed by the decoder 240, extraction of the audio synchronization signal ASYNC and/or an audio signal generated by the audio signal output unit 250, in S340 through S360, may be performed in response to the play signal PLAY.

A user may generate a play signal PLAY that initiates decoding and extracting operations and/or generation of an audio signal, regardless of whether the user requests reproduction of an ancillary data file. If the user requests reproduction of an ancillary data file, an ancillary data request signal REQ may be generated and the processor 230 may extract ancillary data ANCD corresponding to the audio synchronization signal ASYNC, in S370. The ancillary data ANCD may be extracted from the ancillary data storage unit 200.

A user may desire to see a background image corresponding to a reproduced audio file during an audio file reproduction operation. Conversely, a user may desire to discontinue a background image during an audio file reproduction operation and/or after an audio file has been reproduced. The ancillary data request signal REQ may be generated simultaneously with the beginning of an audio file reproduction operation and/or during an existing audio file reproduction operation, according to the user's request.

FIGS. 4A-4C are exemplary views of ancillary data ANCD, according to an exemplary embodiment of the present invention. Referring to FIGS. 4A-4C, ancillary data ANCD may be extracted from the ancillary data storage unit 220, and may have a structure that includes for example, a seek control frame SCF, video control frame VCF, and/or a text data frame TDF. Referring to FIG. 4A, the seek control frame SCF may include, for example, audio data frame location information, video control frame VCF location information and/or text data frame TDF location information.

The audio data frame location information may indicate a start location of an audio data frame, and may be in the decoded audio data DECAUD. The video control frame VCF location information may correspond to the audio data frame location and/or indicate a start location of a video control frame VCF. The text data frame TDF location information may correspond to the audio data frame location and and/or indicate a start location of a text data frame TDF. Further, the seek control frame SCF may include synchronization information that indicates a start time for ancillary ANCD.

Referring to FIG. 4B, the video control frame VCF may include identity information to indicate whether the pronounced text corresponds to a sentence of a previous audio frame or a different audio frame. The video control frame VCF may further include text order information, information for a frame length of pronounced text and/or background image data related to still and/or moving image data. The identity information may correspond to the location information of the video control frame VCF, and may indicate whether pronounced text in a current frame exists within the sentence of a previous audio frame. For example, sentences may be divided by a period separating text data, and the text data within different sentences may contain different identity information. The text information order may correspond to video control frame VCF location information, and may indicate order information for currently pronounced text among currently displayed text. The text order information may, for example, be used to change the color and/or shadow of text data for displaying the currently pronounced text. Frame length information of the currently pronounced text may correspond to video control frame VCF location information, and may indicate video frames during which the currently pronounced text may be pronounced.

The background image data, according to an exemplary embodiment of the present invention, may include information that indicates whether still image data or moving-image data exists. The background image data may further include still image or moving-image data if the data is found to exist. If no background image data exists, then a subsequent data frame may be a different video control frame VCF or text data frame TDF. Further, the video control frame VCF may include video control synchronization information indicating a start timing of the video control frame VCF.

Referring to FIG. 4C, the text data frame TDF may include text count information, text data and/or text data synchronization information. The text count information may correspond to text data frame TDF location information and may provide an indication for a number of text segments of a sentence including a currently pronounced text. The text data may be text data of the sentence and may include currently pronounced text. The text data synchronization information may indicate a start timing of the text data frame TDF.

The ancillary data ANCD, according to an exemplary embodiment of the present invention, may be extracted from the ancillary data storage unit 220. The ancillary data ANCD may be analyzed by the synchronization and ancillary data output unit 260 and display data SYNCD may be extracted and outputted in synchronization with the audio synchronization signal ASYNC, in S380 of FIG. 3. The display data SYNCD may include image data and text data and may be displayed along with the ancillary data ANCD. The display data SYNCD may further include synchronization data for providing synchronization for the audio synchronization signal ASYNC.

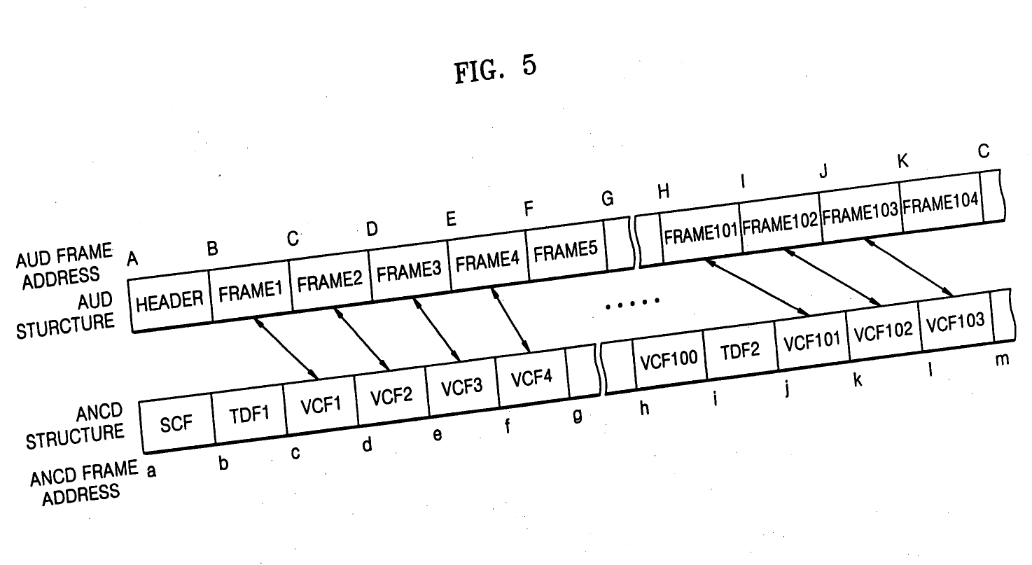

FIG. 5 is an exemplary view of a corresponding relationship between an audio data stream AUD and an ancillary data stream ANCD, according to an exemplary embodiment of the present invention. An audio data stream AUD may be compressed according to an MPEG standard and segmented by a frame unit. The frame unit may be segmented to a size smaller than 0.25 second and may include a header indicating a start time. The decoder 240 may decode the audio data stream AUD output from the audio data storage unit 210 and generate an audio synchronization signal ASYNC. The synchronization and ancillary data output unit 260 may analyze and/or extract display data SYNCD corresponding to the audio synchronization signal ASYNC. In the exemplary view illustrated in FIG. 5, the audio data stream AUD may include frames, for example FRAME1-FRAME4 corresponding to respective video control frames VCF1-VCF4. In FIG. 5, the ancillary data stream ANCD may include, for example, a seek control frame SCF, a text data frame TDF1 and a video control frame VCF1. The order of the frames may be changed if an address corresponding to the frame information is detected. The text data frame, for example TDF1, may correspond to more than one video control frames VCF. Since a text data frame TDF may include text data displayed in a sentence and/or currently pronounced text data, the number of video control frames VCF corresponding to a text data frame TDF may be set based on a prediction of the number of text segments to be displayed on a display device.

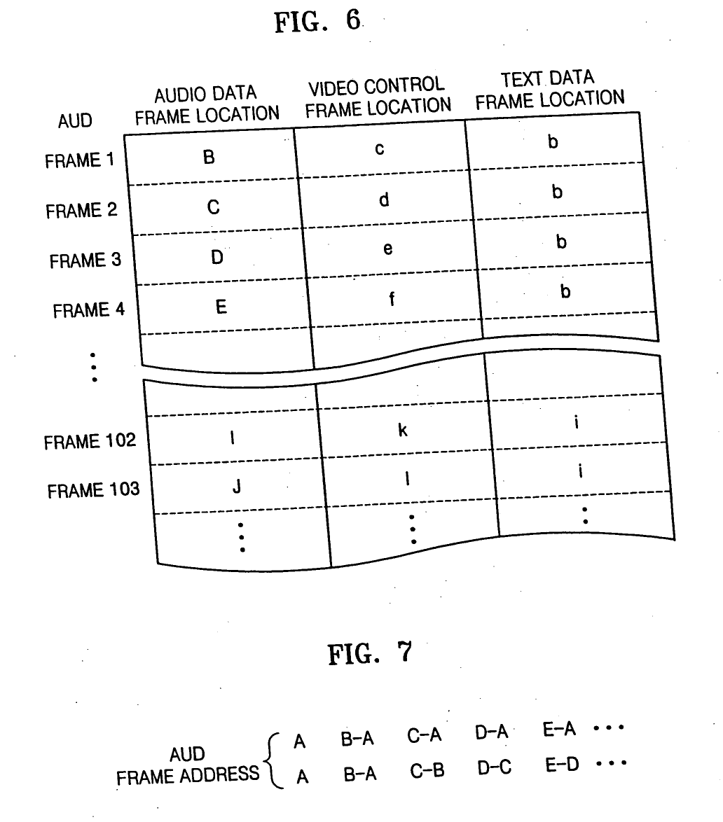

FIG. 6 according to an exemplary embodiment of the present invention, illustrates an example structure of a seek control frame SCF corresponding to FIG. 4A. Referring to FIG. 6, a seek control frame SCF may include audio data frame location information, video control frame VCF location information and/or text data frame TDF location information. The SCF may also include frame location information corresponding to audio frame location information. Referring to FIG. 5, a first audio data frame may have, for example, an address “B” representing audio data frame location information, an address “c” representing video control frame VCF location information, and/or an address “b”, representing text data frame TDF location information. The address “b” may represent a start location of a text data frame TDF1 corresponding to one or more video control frames, for example VCF1-VCF4. Another example for instance, a 102-th audio data frame FRAME102 may have an address “I” corresponding to a video data frame VCF102 having an address “k” and a text data frame location TDF2 having an address “i”.

FIG. 7 according to an exemplary embodiment of the present invention, illustrates examples of setting an address of an audio data frame. Referring to FIG. 7, a first example provides setting an audio frame address value by subtracting an address “A” of a header frame from an address of a corresponding frame. The second example provides setting an address value based on a difference between addresses of neighboring frames.

In an exemplary embodiment of FIG. 2, the synchronization and ancillary data output unit 260 may analyze text data frames TDF and video control frames VCF corresponding to respective frames of an audio data stream AUD. Referring to FIG. 3 the ancillary data output unit may extract display data, for example SYNCD corresponding to an audio synchronization signal ASYNC, in S380. The video controller 270 may extract and output text data corresponding to the pronounced audio data from the display data SYNCD. The text data may be displayed on a display device, for example a LCD, and may be displayed when the decoded audio data DECAUD is pronounced by an audio signal device, for example a speaker. The video controller 270 may output text data corresponding to a specified number of text segments within a sentence using the text count information of a corresponding text data frame TDF. The text data output may include, for example, a currently pronounced text output using a different color signal. For example, one frame before the text is pronounced the text order information of a corresponding video control frame VCF and frame length information of the currently pronounced text may provide information for a different color signal.

A user may be able to request a jump in the order of pronounced audio data, for example to repetitively hear a same sentence and/or to skip a sentence and hear a different sentence. If the user requests a jump using a specified input key (not shown), the decoder 240 may decode an audio data frame at the corresponding jumped location. Also, the video controller 270 may provide output text data corresponding to the audio data frame at the jumped location based on identity information, for example, contained in a video control frame VCF.

Text data and/or background image data may be extracted from display data and input to the video signal output unit 280. The video signal output unit 280 may generate a video signal for driving a display device, for example, a LCD viewable by a user, in S390 of FIG. 3.

According to an exemplary embodiment of the present invention, an audio file and/or ancillary image data may be stored as a separate file and may be received and reproduced by audio/video reproducing apparatus 200. The ancillary data may be synchronized with the audio data to display music lyrics and/or subtitles of documents or movies. The audio/video reproducing apparatus 200 may display a currently pronounced text using a different color from other text data displayed. The applications of the audio/video reproducing apparatus 200 may provide a visual user aid, for example, for studying a foreign language and/or for performing karaoke.

In the audio/video reproducing apparatus 200, according to an exemplary embodiment of the present invention, ancillary data for subtitles and background images may not be decoded in the decoder 240, thus reducing memory loss in the decoder. If ancillary image data is stored separately, for example as a separate file, the amount of ancillary information stored may be increased, thus providing a larger capacity of ancillary video information.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An audio/video reproducing apparatus comprising:
an audio data storage unit storing audio data;
an ancillary data storage unit storing ancillary data;
a decoder decoding the audio data and outputting decoded audio data and an audio synchronization signal;
a processor extracting at least a portion of said ancillary data corresponding to the audio synchronization signal from the ancillary data storage unit in response to an ancillary data request signal;
a synchronization and ancillary data output unit analyzing the extracted ancillary data and outputting display data in synchronization with the audio synchronization signal; and
a video controller extracting, from the display data, text data corresponding to pronounced audio data, which is displayed on a display when the decoded audio data is pronounced by an audio device.

2. The apparatus of claim 1, wherein the extracted ancillary data includes a seek control frame, a video control frame and a text data frame.

3. The apparatus of claim 2, wherein the seek control frame includes information regarding,
an audio data frame location of the decoded audio data,
a video control frame location, and
a text data frame location corresponding to the audio data frame location.

4. The apparatus of claim 2, wherein the video control frame includes identity information indicating,
whether the text data exists in a sentence of a previous audio frame,
text order information,
information for a frame length of pronounced text corresponding to the pronounced audio data, and
information for background image data corresponding to the video control frame location information; and
wherein the text data frame includes text count information and text data corresponding to text data frame location information.

5. The apparatus of claim 1, wherein the synchronization and ancillary data output unit outputs the background image data and the text data as the display data in synchronization with the audio synchronization signal.

6. The apparatus of claim 1, wherein the video controller extracts background image data corresponding to the pronounced audio data to be displayed on the display.

7. The apparatus of claim 6, wherein the background image data is at least one of still image data and moving-image data.

8. The apparatus of claim 1, wherein the text data output from the video controller corresponds to at least one of text of a sentence and a currently pronounced text.

9. The apparatus of claim 8, wherein the video controller outputs the text data corresponding to the currently pronounced text using a first text color before the text data is pronounced based on the text order information and frame length information of the currently pronounced text, and wherein the video controller outputs the text data using a second text color during the time the currently pronounced text is being pronounced.

10. The apparatus of claim 4, wherein the video controller outputs the text at a jumped location based on the identity information.

11. A method of reproducing audio/video comprising:
extracting audio data from a first storage unit;
decoding the audio data;
outputting the decoded audio data;
extracting at least one audio synchronization signal using the decoded audio data;
extracting ancillary data, corresponding to the at least one audio synchronization signal, from a second storage unit in response to an ancillary data request signal;
outputting display data in synchronization with the at least one audio synchronization signal;
extracting text data from the display data, said text data corresponding to the decoded audio data; and
displaying the text data on a display when the decoded audio data is pronounced by an audio device.

12. The method of claim 11, wherein extracting the ancillary data includes extracting a seek control frame, a video control frame and a text data frame.

13. The method of claim 12, wherein the seek control frame includes information regarding,
an audio data frame location of the decoded audio data,
a video control frame location, and
a text data frame location corresponding to the audio data frame location.

14. The method of claim 12, wherein the video control frame includes identity information indicating,
whether the text data exists in a sentence of a previous audio frame,
text order information,
information for a frame length of pronounced text corresponding to the pronounced audio data, and
information for background image data corresponding to the video control frame location information; and
wherein the text data frame includes text count information and text data corresponding to text data frame location information.

15. The method of claim 14, wherein the outputting of the display data includes outputting the background image data and the text data as the display data in synchronization with the audio synchronization signal.

16. The method of claim 11, wherein the displaying of the text data includes extracting background image data corresponding to the pronounced audio data to be displayed on the display.

17. The method of claim 16, wherein the background image data is at least one of still image data and moving-image data.

18. The method of claim 11, wherein the displayed text data corresponds to at least one of text of a sentence and a currently pronounced text.

19. The method of claim 18, wherein the displayed text data corresponding to the currently pronounced text is displayed using a first text color before the text data is pronounced based on the text order information and frame length information of the currently pronounced text, and wherein the displayed text data is displayed using a second text color during the time the currently pronounced text is being pronounced.

20. The method of claim 14, wherein the text data is output corresponding to an audio data frame at a jumped location using the identity information.

21. An audio/video reproducing apparatus comprising:
an audio data storage unit storing audio data;
an ancillary data storage unit storing ancillary data;
a processor extracting the audio data from the audio data storage unit in response to a first signal, and extracting ancillary data corresponding to an audio synchronization signal from the ancillary data storage unit in response to a second signal data request signal; and
a synchronization and ancillary data output unit analyzing the extracted ancillary data and outputting display data in synchronization with the audio synchronization signal.

22. The apparatus of claim 21, wherein the first signal is a PLAY signal.

23. The apparatus of claim 22, wherein the PLAY signal is generated when a user selects an audio file and requests reproduction of the audio file.

24. The apparatus of claim 21, wherein the second signal is a request signal generated by a user request for reproduction of an ancillary data file.

25. The apparatus of claim 24, wherein the reproduction of an ancillary data file provides a user to view at least one of a subtitle display and a background image display.

26. A method comprising:
extracting audio data in response to a request for reproduction of at least one audio file;
decoding the audio data;
extracting an audio synchronization signal using the decoded audio data; and
generating an audio signal from the decoded audio data for driving an audio device.

27. The method of claim 26, wherein only the audio data is decoded when no request for ancillary data is received.

28. The method of claim 26, wherein ancillary data is extracted corresponding to the audio synchronization signal in response to an ancillary data request signal.

29. A method comprising:
extracting at least one audio synchronization signal using decoded audio data;
extracting ancillary data corresponding to the at least one audio synchronization signal in response to an ancillary data request signal;
outputting display data in synchronization with the at least one audio synchronization signal;
extracting text data from the display data, said text data corresponding to the decoded audio data; and
displaying the text data on a display when the decoded audio data is pronounced by an audio device.

30. An audio/video reproducing apparatus controlled in accordance with the method of claim 11.

31. An audio/video reproducing apparatus controlled in accordance with the method of claim 26.

32. An audio/video reproducing apparatus controlled in accordance with the method of claim 29.
